(19) United States
(12) Patent Application Publication
(10) Pub. No.: US 2025/0280073 A1
(43) Pub. Date: Sep. 4, 2025

(54) RECORDING MEDIUM STORING INFORMATION PROCESSING PROGRAM AND INFORMATION PROCESSING DEVICE

(71) Applicant: Konica Minolta, Inc., Tokyo (JP)

(72) Inventors: Hiroyuki Mitani, Toyokawa-shi (JP); Kenji Ono, Toyokawa-shi (JP); Junichi Arai, Toyokawa-shi (JP)

(73) Assignee: Konica Minolta, Inc., Tokyo (JP)

(21) Appl. No.: 19/065,108

(22) Filed: Feb. 27, 2025

(30) Foreign Application Priority Data
Feb. 29, 2024 (JP) 2024-029258

(51) Int. Cl. H04N 1/00

(52) U.S. Cl. CPC H04N 1/00029; H04N 1/00413

(57) ABSTRACT

Disclosed is a non-transitory computer-readable recording medium storing an information processing program that causes a computer to execute display processing of displaying, on a display part, an image of visual structural information allowing visual grasp of a structure of a diagnosis target apparatus and a mark superimposed on the visual structural information to allow recognition of a location in the visual structural information corresponding to a component or a region of the diagnosis target apparatus in which an abnormality may have been generated, the component or the region being obtained by analyzing sound data on a sound generated in the diagnosis target apparatus.

### CROSS-REFERENCE TO RELATED APPLICATIONS

The entire disclosure of Japanese Patent Application No. 2024-029258 filed on Feb. 29, 2024, is incorporated herein by reference in its entirety.

### BACKGROUND OF THE INVENTION

### Technical Field

The present invention relates to a recording medium storing an information processing program, and an information processing device.

### Description of Related Art

As a system for diagnosing a diagnosis target apparatus such as an image forming apparatus, a system disclosed in Japanese Patent No. 5939480 is known.

When an abnormal sound is generated, the diagnosis system acquires sound data by collecting the generated abnormal sound, and receives recording location information as location information about the location where the generated abnormal sound is recorded. Next, the diagnostic system extracts a waveform that is similar to the frequency spectrum waveform obtained by performing frequency analysis on the acquired sound data of the abnormal sound. Furthermore, the diagnostic system narrows down the components that may be the cause of the abnormal sound based on the recording location information (location information of the abnormal sound) and explains and displays the cause of the abnormal sound and a coping method. In addition, the diagnostic system displays the names or component numbers of the components that may be the cause of the abnormal sound.

### SUMMARY OF THE INVENTION

However, although the above-described diagnostic system can narrow down the components in which the abnormal sound is generated, it is not possible to visually grasp the components that may be the cause of the abnormal sound.

The knowledge of the diagnosis target apparatus differs depending on a worker. Even when a candidate for the abnormal sound generating component (information identifying the cause of the abnormal sound) is displayed as text information an unskilled person or a user himself/herself often does not know the location of the candidate. In such a case, it is necessary to make an inquiry to a support center or confirm the location of the candidate for the abnormal sound generating component by a manual or the like. Therefore, a decrease in work efficiency is caused, and since the location of the candidate for the abnormal sound generating component cannot be visually grasped, there is also a risk that the target component is erroneously recognized.

The present invention has been made in view of such circumstances, and objects thereof include improving work efficiency at the time of maintenance of a diagnosis target apparatus.

To achieve at least one of the abovementioned objects, a non-transitory computer-readable recording medium reflecting one aspect of the present invention stores an information processing program, wherein the program causes a computer to execute display processing of displaying, on a display part, an image of visual structural information allowing visual grasp of a structure of a diagnosis target apparatus and a mark superimposed on the visual structural information to allow recognition of a location in the visual structural information corresponding to a component or a region of the diagnosis target apparatus in which an abnormality may have been generated, the component or the region being obtained by analyzing sound data on a sound generated in the diagnosis target apparatus.

To achieve at least one of the abovementioned objects, an information processing device reflecting another aspect of the present invention comprises: a display part that displays information; and a display processor that causes the display part to display an image in which a mark allowing recognition of a location corresponding to a component or a region of a diagnosis target apparatus in which an abnormality may have been generated is superimposed on visual structural information allowing visual grasp of a structure of the diagnosis target apparatus, the component or the region being obtained by analyzing sound data on a sound generated in the diagnosis target apparatus.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a schematic diagram illustrating an information processing system for supporting an abnormal sound diagnosis according to the present embodiment;

FIG. 2A is a block diagram illustrating a functional configuration of an information processing device (diagnostic terminal) used in the information processing system according to the present embodiment;

FIG. 2B is a block diagram illustrating a functional configuration of a server used in the information processing system according to the present embodiment;

FIG. 3 is a flowchart illustrating an operation process of the information processing device (diagnostic terminal) according to the present embodiment;

FIG. 4 is a diagram illustrating an operation screen for performing an operation of collecting an abnormal sound and an operation of starting analysis in the information processing device (diagnostic terminal) according to the present embodiment;

FIG. 5 is a diagram illustrating a screen of an analysis result of the information processing device (diagnostic terminal) according to the present embodiment;

FIG. 6 is a flowchart illustrating another operation process of the information processing device (diagnostic terminal) according to the present embodiment;

FIG. 7 is a flowchart illustrating still another operation process of the information processing device (diagnostic terminal) according to the present embodiment;

FIG. 8 is a diagram illustrating a screen on a display part on which a list of candidates for an abnormal sound generating component is displayed and the locations of the candidates for the abnormal sound generating component are superimposed by marks in visual structural information;

FIG. 9 is a diagram illustrating a change in the sizes of the marks indicating the locations of the candidates for the abnormal sound generating component in accordance with the sizes of the candidates on the screen of FIG. 8;

FIG. 10 is a diagram illustrating a screen when the screen of FIG. 8 is changed such that the visual structural information shows a different side of a diagnosis target apparatus than in FIG. 8;

FIG. 11 is a diagram illustrating a screen when the screen of FIG. 8 is changed such that the visual structural information shows the top of the diagnosis target apparatus;

FIG. 12A is a diagram illustrating a state in which no component is selected on the screen of FIG. 8;

FIG. 12B is a diagram illustrating a screen when a component A is selected on the screen from the state illustrated in FIG. 12A;

FIG. 12C is a diagram illustrating a screen when a component D is further selected on the screen from the state illustrated in FIG. 12B;

FIG. 13 is a diagram illustrating another screen on which the list of the candidates for the abnormal sound generating component and the marks of the locations of the candidates for the abnormal sound generating component in the visual structural information are associated with each other;

FIG. 14 is a diagram illustrating a screen on which drive source information is added to the list of the candidates for the abnormal sound generating component;

FIG. 15A is a diagram illustrating a screen on which the drive source information is added to a list of candidates for the abnormal sound generating component when there are many candidates for the abnormal sound generating component;

FIG. 15B is a diagram illustrating a screen on which the number of the candidates for the abnormal sound generating component driven by each drive source is displayed on the list of the candidates for the abnormal sound generating component;

FIG. 15C is a diagram illustrating a screen on which the names of the candidates for the abnormal sound generating component driven by each drive source are displayed on the list of the candidates for the abnormal sound generating component;

FIG. 16 is a diagram illustrating a screen on the display part on which a list of regions in which the abnormal sound may have been generated is displayed. and the regions are superimposed by marks in the visual structural information; and

FIG. 17 is a control block diagram illustrating a case where the diagnosis target apparatus itself, which is a generation source of an abnormal sound, collects an abnormal sound, analyzes the abnormal sound, and performs various displays.

### DETAILED DESCRIPTION

Hereinafter, one or more embodiments of an information processing device according to the present invention will be described with reference to the drawings. The information processing device according to the present invention is a device that supports an abnormality diagnosis for identifying a location of abnormality generation in a diagnosis target apparatus. In these embodiments, a case will be described in which an image forming apparatus 4 is diagnosed and the information processing device assists in identifying the cause of an abnormal sound. However, the scope of the present invention is not limited to the disclosed embodiments.

### First Embodiment

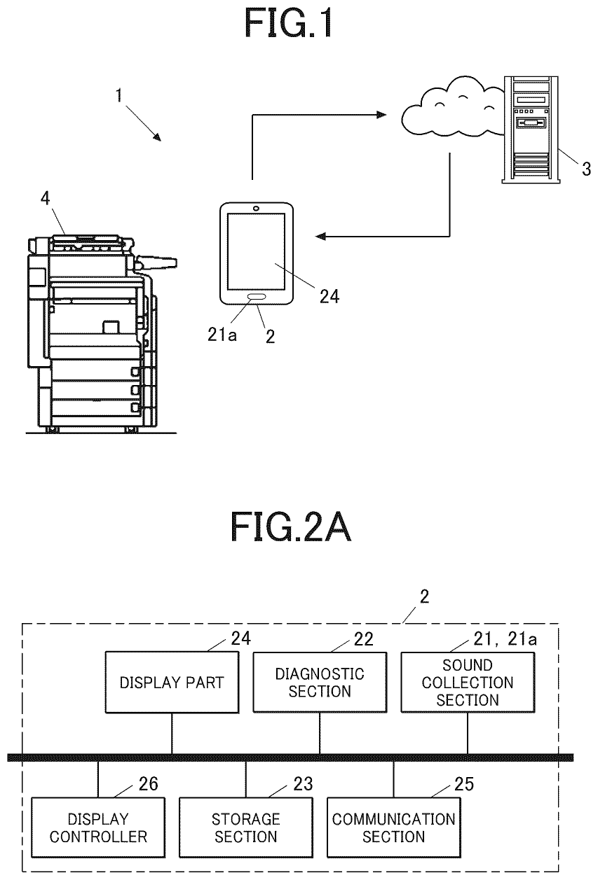

In FIG. 1, a schematic configuration of an information processing system 1 for identifying the cause of the abnormal sound is illustrated. The information processing system 1 includes a diagnostic terminal 2 as the information processing device and a server 3 communicably coupled to the diagnostic terminal 2.

The diagnostic terminal 2 is a portable device such as a personal computer, a smartphone, or a tablet terminal. The diagnostic terminal 2 is carried by a service person who performs maintenance, repair, and the like on a diagnosis target apparatus such as the image forming apparatus 4 used by an end user. The diagnostic terminals 2 functions as a computer for acquiring sound data of the abnormal sound generated in the image forming apparatus 4, extracting a candidate for an abnormal sound generating component by analyzing the acquired sound data, and displaying an analysis result, an extraction result, and the like.

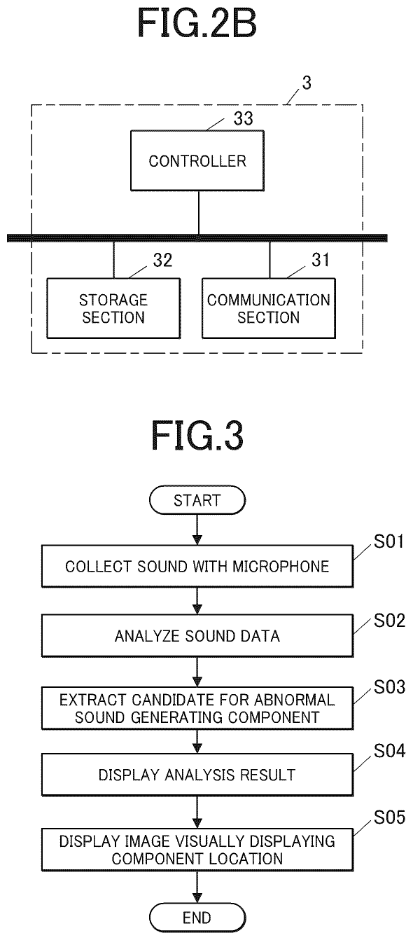

As illustrated in FIG. 2A, the diagnostic terminal 2 includes a sound collection section (sound collector) 21, a diagnostic section (analyzer) 22, a storage section 23, a display part 24, a communication section 25, and a display controller (display processor) 26.

The sound collection section 21 includes a sound collecting microphone 21a, which is a well-known acoustic unit that converts a detected sound into an electrical signal (sound data). The sound collecting microphone 21a may be built in or externally attached to the diagnostic terminal 2.

The diagnostic section 22 includes an arithmetic processor including one or more central processing units (CPUs), micro-processing units (MPUs), graphics processing units (GPUs), and the like. The arithmetic processor reads and executes programs stored in the storage section 23 to perform various information processing, control processing, and the like of the diagnostic terminal 2.

The storage section 23 stores the programs for performing information processing, control processing, and the like at the diagnostic terminal 2, and stores the sound data collected by the sound collection section 21, the analysis result, and the like. Here, the programs include an information processing program for an abnormal sound diagnosis that causes the diagnostic terminal 2 to perform processing such as acquisition and analysis of sound data of an abnormal sound, extraction of a candidate for a component (abnormal sound generating component) that may be the cause of the abnormal sound, and display of an analysis result and an extraction result, which will be described later.

This information processing program may be installed in the storage section 23 of the diagnostic terminal 2 via a predetermined recording medium. Alternatively, the information processing program may be downloaded via a network and installed in the storage section 23 of the diagnostic terminal 2.

The diagnostic section 22 reads and executes the information processing program loaded in the storage section 23 and analyzes the sound data collected by the sound collection section 21. Then, a process is performed to compare the detection period of abnormal sounds with the pitch period of a movable component mounted on the image forming apparatus 4 to extract a candidate for the abnormal sound generating component.

In addition, the storage section 23 stores various pieces of information for identifying a candidate for the abnormal sound generating component, such as:
The pitch period of a movable component of the diagnosis target apparatus (image forming apparatus 4);
Mounting location information specifying the mounting location of a component that may generate an abnormal sound in the diagnosis target apparatus (image forming apparatus 4);
Size information of a component mounted on the diagnosis target apparatus (image forming apparatus 4); and
Information about a drive source of a component of the diagnosis target apparatus (image forming apparatus 4).

The storage section 23 also stores structural information (visual structural information) that visually shows the structure of the diagnosis target apparatus (image forming apparatus 4 ) in two or three dimensions.

Here, the visual structural information of the diagnosis target apparatus (image forming apparatus 4) indicates information displayed so that the structure of the diagnosis target apparatus can be visually grasped. The visual structural information includes a two-dimensional projection image and a three-dimensional image of the image forming apparatus 4. The images includes a photograph, a drawing, and an illustration of an external structure such as a side surface or a flat surface, a structure which can be grasped with a door open, or a structure arranged for guidance. In the present embodiment, an example using an external structural view (two-dimensional projection view) of the image forming apparatus 4 is shown.

The display part 24 includes, for example, a flat panel display such as a liquid crystal display or an organic EL display. The display part 24 displays various operation screens, diagnosis results, various images, and the like based on a display control signal from the display controller 26.

The communication section 25 is a communication module or a communication interface for communicating with the server 3 via a network in a wired or wireless manner. For example, the communication section 25 is a narrow area wireless communication module such as Wi-Fi (registered trademark) and Bluetooth (registered trademark), or a wide area wireless communication module such as 5G, 4G and LTE. The diagnostic terminal 2 and the server 3 are coupled to each other via a wired or wireless LAN or an Internet communication network, allowing for the transmission and reception of information.

The display controller 26 includes an arithmetic processor that is the same as or different from the diagnostic section 22 and reads and executes the information processing program loaded in the storage section 23. The display controller performs processing such as displaying, on the display part 24, a diagnostic result diagnosed by the diagnostic section 22, a candidate for the abnormal sound generating component extracted by the diagnostic section 22, an image visually indicating the location of the abnormal sound generating component, and the like (details will be described later).

As illustrated in FIG. 2B. the server 3 includes a communication section 31, a storage section 32, and a controller 33. The server 3 includes not only a single server but also a cloud server constituted by a plurality of computers, or a virtual server.

The communication section 31 is a communication module or a communication interface for communicating with the diagnostic terminal 2 via a network in a wired or wireless manner. The communication section 31 couples the diagnostic terminal 2 and the server 3 via a wired or wireless LAN or an Internet communication network to transmit and receive information.

The storage section 32 stores programs for performing information processing, control processing, and the like in the server 3, and stores various kinds of information sent from the diagnostic terminal 2.

The controller 33 includes an arithmetic processor including one or more central processing units (CPUs), micro-processing units (MPUs), graphics processing units (GPUs), and the like. The arithmetic processor reads and executes programs stored in the storage section 32 to perform various information processing, control processing. and the like of the server 3.

The storage section 23 and the diagnostic section 22 of the diagnostic terminal 2 may be disposed in the server 3 (may be substituted by the storage section 32 and the controller 33 of the server 3). In this case, various information and programs stored in the storage section 23 of the diagnostic terminal 2 are also stored in the storage section 32 of the server 3. Then, the sound data of the abnormal sound collected by the diagnostic terminal 2 may be transmitted to the server 3, and the controller 33 of the server 3 may perform the same process as the diagnostic section 22 of the diagnostic terminal 2.

In the present embodiment, a case will be described where an abnormal sound is generated in the image forming apparatus 4, which is a diagnosis target apparatus installed at an end user's site.

When an abnormal sound is generated in the image forming apparatus 4 installed at the end user's site, a service person goes to the installation site of the image forming apparatus 4 while carrying the diagnostic terminal (for example, a portable terminal) 2. Then, the service person acquires sound data of the abnormal sound by recording the abnormal sound being generated using the diagnostic terminal 2 and performs the abnormal sound diagnosis to identify the causing component that generates the abnormal sound.

An operation of the diagnostic terminal 2 according to the present embodiment will be described with reference to a flowchart in FIG. 3.

First, at the diagnostic terminal 2, the built-in sound collecting microphone 21a (the sound collection section 21) is brought close to the abnormal sound generation place of the image forming apparatus 4 to record the abnormal sound, and the sound data is acquired (collecting the sound with the microphone: step S01).

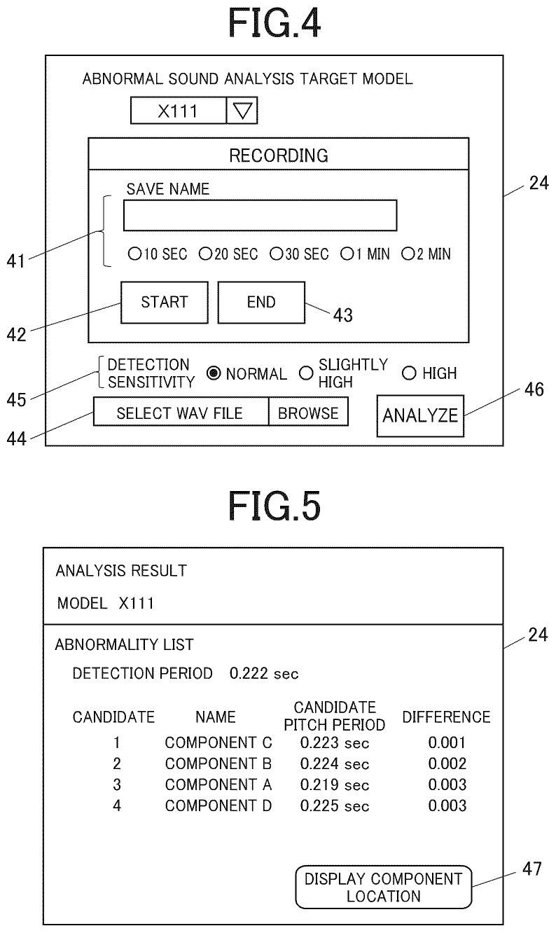

For example, the display part 24 of the diagnostic terminal 2 displays an operation screen for recording a sound, as illustrated in FIG. 4.

On this operation screen, a settings portion 41 for setting information necessary for recording a sound (for example, the save name of a recording file and a recording time), a start button 42 and end button 43 for instructing the start and end of the recording, and the like are arranged. By setting the information necessary for the recording and pressing the start button 42, the sound data of the abnormal sound is stored in the storage section 23 in a predetermined file format. In this case, the recorded sound data may be transmitted to the server 3 via the communication section 25 to be stored in the storage section 32 of the server 3.

Next, the acquired sound is analyzed (step S02). As illustrated in FIG. 4, on the operation screen of the display part 24, a file selection portion 44 for selecting a sound file in which a sound is recorded, a settings portion 45 for setting a parameter (for example, detection sensitivity or the like) necessary for analysis, an analysis button 46 for executing analysis, and the like are arranged. The analysis is executed by designating a file of the sound data stored in the storage section 23, designating the detection sensitivity and the like, and pressing the analysis button 46.

This analysis may be performed each time the execution operation is input from the screen of FIG. 4. Alternatively, parameters may be set in advance, and the analysis may be automatically performed after recording of a sound is completed.

There are various methods for the analysis of a sound. For example, a spectrogram (three-dimensional data of frequency×time×amplitude) is created in which spectra obtained by decomposing the sound (sound waveform) into frequency components by Fourier transformation (short-time discrete Fourier transformation) are arranged in the time direction. Thereafter, the data set is clustered to extract only the abnormal sound, thereby identifying the period of the abnormal sound. Then, the period of the abnormal sound is checked against the rotation period (pitch period) of each component. By extracting a component having the same period as or the period close to the abnormal sound period, a candidate for the abnormal sound generating component that may be the cause of the abnormal sound is extracted (step S03). In the extraction of a candidate for the abnormal sound generating component, for example, a component having the rotation period (candidate pitch period) within a range of a predetermined difference from the period (detection period) of the abnormal sound is extracted.

Then, as an analysis result, the detection period of the abnormal sound and candidates for the abnormal sound generating component having the same period as or the period close to the detection period are displayed on a list, for example, as illustrated in FIG. 5. On the screen of the analysis result, components having the period close to the detection period of the abnormal sound are displayed from those with smaller differences (step S04).

Thereafter, by pressing a “display component location” button +7 provided on the screen of the analysis result, the screen is switched to a screen on which it is possible to visually recognize the location of each of the extracted candidates for the abnormal sound generating component in the diagnosis target apparatus (image forming apparatus 4 ) (step S05).

In the above example, the analysis of the sound data and the extraction of the candidates for the abnormal sound generating component are performed by the diagnostic terminal 2. In this example, the processes from the collection of the abnormal sound to the display of the locations of the candidates for the abnormal sound generating component are performed by the diagnostic terminal 2. However, as described above, the sound data collected by the diagnostic terminal 2 may be transmitted to the server 3, and the server 3 may perform the analysis or the like.

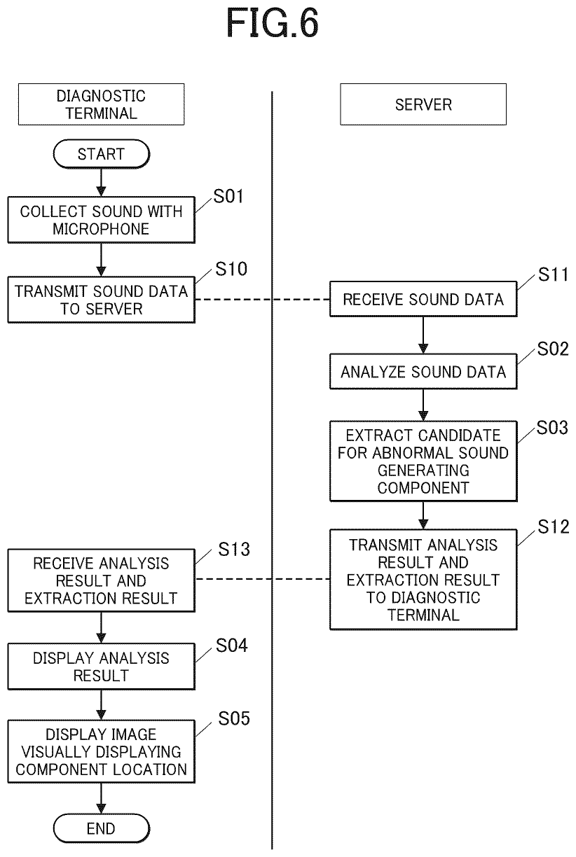

That is, as illustrated in FIG. 6, the sound data of the abnormal sound collected in step S01 is transmitted to the server 3 (step S10), the sound data is received by the server 3 (step S11), and then the processes of steps S02 and S03 are performed by the server 3. Thereafter, the analysis result and the extraction result of the candidates for the abnormal sound generating component are transmitted from the server 3 to the diagnostic terminal 2 (step S12). After receiving the analysis result and the extraction result (step S13), the diagnostic terminal 2 may perform the subsequent processes (steps S04 and S05) such as displaying the analysis result.

Here, the processes of transmitting the sound data from the diagnostic terminal 2 to the server 3 and receiving the sound data by the server 3 (S10 and S11) use a communication line, but the data may be transferred via a storage medium such as a USB or a CD. Furthermore, in the processes of transmitting the analysis result and the extraction result from the server 3 to the diagnostic terminal 2 and receiving the analysis result and the extraction result by the diagnostic terminal 2 (S12 and S13), the data may be transferred via a storage medium such as a USB or a CD as well.

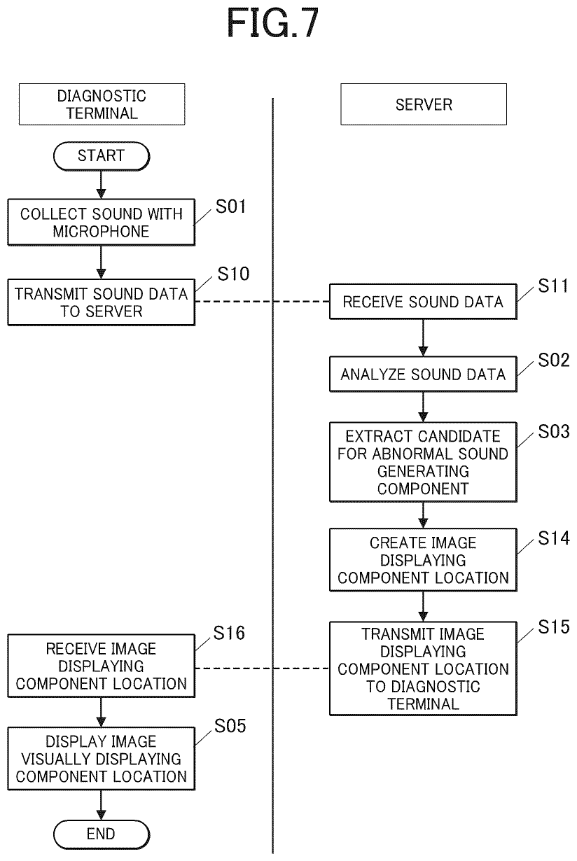

Furthermore, as illustrated in FIG. 7, after the server 3 performs the processes of steps S02 and S03, the server 3 may further create an image in which the locations of the candidates for the abnormal sound generating component can be visually recognized (an image in which the component locations are visually displayed) (step S14). Thereafter, the server 3 transmits the image to the diagnostic terminal 2 (step S15). After receiving the image (step S16), the diagnostic terminal 2 may display, on the display part 24, the image in which the locations of the candidates for the abnormal sound generating component are visually displayed (step S05).

Here, too, the processes of transmitting the sound data from the diagnostic terminal 2 to the server 3 and receiving the sound data by the server apparatus 3 (S10 and S11) use a communication line, but the data may be transferred via a storage medium such as a USB or a CD. Furthermore, in the processes in which the image in which the component locations are displayed is transmitted from the server 3 to the diagnostic terminal 2 and the image in which the component locations are displayed is received by the diagnostic terminal 2 (S15 and S16), the data may be transferred via a storage medium such as a USB or a CD as well.

Note that the processes of acquiring the sound data of the abnormal sound and transmitting the sound data to the server 3 in step S01 may be performed by the diagnostic terminal 2 or another device other than the diagnostic terminal 2.

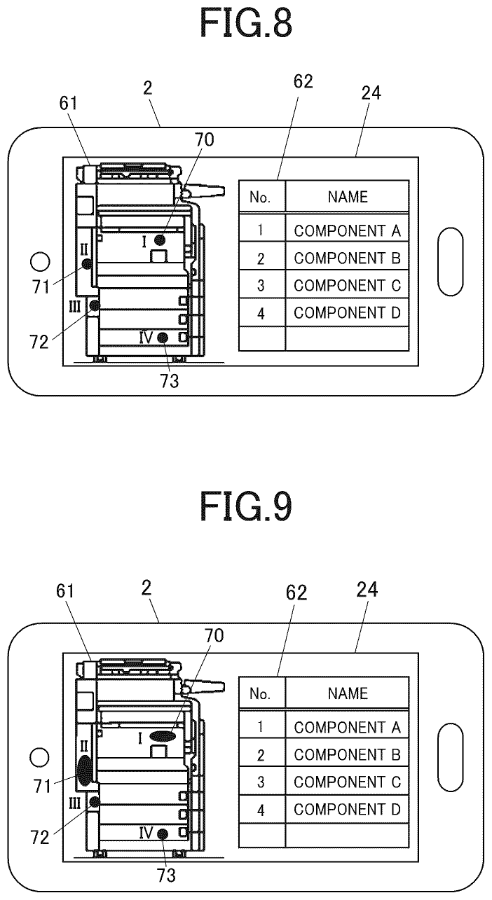

Furthermore, in the above-described example, the candidates for the abnormal sound generating component (the candidates for the component that may be the cause of the abnormal sound) extracted as the analysis result are displayed, and then the location of the candidate for the abnormal sound generating component extracted by an operation of the worker (pressing the “display component location” button) is displayed. On the other hand, the display of the analysis result may be omitted. In this case, screens on which the locations of the respective candidates for the abnormal sound generating component can be visually recognized may be directly transmitted to the diagnostic terminal 2. Then, after receiving the screens, the diagnostic terminal 2 may display the screens illustrated in FIG. 8 and subsequent drawings on the display part 24.

FIG. 8 illustrates a screen on the display part 24 that allows the user to visually recognize the locations of the extracted candidates for the abnormal sound generating component. The visual structural information 61 of the image forming apparatus 4 (diagnosis target apparatus) stored in the storage section 23 is displayed on the display part 24. In this example, a left side view of the image forming apparatus 4 is displayed as the visual structural information 61. In addition, a list 62 of the candidates for the abnormal sound generating component (candidates for the component that may be the cause of the abnormal sound) extracted by the analysis is also shown next to the visual structural information 61 on the display part 24.

In addition, in this example, the list 62 of the candidates for the abnormal sound generating component (candidates for the component that may be the cause of the abnormal sound) is displayed as a list in which the extracted candidates for the component are vertically arranged with the sequential numbers starting from 1 and the component names.

In addition, marks 70 to 73 each indicating the locations of the candidates for the abnormal sound generating component are superimposed on the visual structural information 61 at corresponding places, based on the mounting location information which is stored in the storage section 23 and which specifics the mounting locations of the candidates for the component that may be the cause of the abnormal sound in the diagnosis target apparatus. In this example, black circles are superimposed as the marks indicating the candidates for the abnormal sound generating component.

Roman numerals (I, II, III, and IV) in FIG. 8 correspond to the numbers (Arabic numerals) of the respective components displayed on the list in accordance with the locations of the candidates for the abnormal sound generating component in the visual structural information 61. In this example, the marks of the candidates for the abnormal sound generating component superimposed on the visual structural information 61 are numbered by the Roman numerals in the order in which the marks are displayed from the top. In FIG. 8, there are four candidates for the abnormal sound generating component, and on the list 62 of the candidates for the abnormal sound generating component, the names of the four components are displayed from the top in the order of the Roman numerals in the visual structural information.

Therefore, on the display part 24, marks of the candidates for the abnormal sound generating component arc superimposed on the visual structural information 61; numbers are added in the order in which the marks are displayed from the top; and also on the list 62, the candidates for the abnormal sound generating component are listed in the same order as the numbers in the visual structural information 61. This allows the correspondence relationship between the location of the abnormal sound generating component in the visual structural information and the location of the abnormal sound generating component on the list to be easily understood, eliminating the risk of erroneously recognizing the correspondence relationship.

The above is an example in which the diagnostic terminal 2 creates an image in which marks are displayed at corresponding places in the visual structural information based on the location information about the candidates for the abnormal sound generating component and displays the image on the display part 24. In contrast, a similar image may be created and transmitted to the diagnostic terminal 2 by the server 3 and displayed on the display part 24 of the diagnostic terminal 2. Here, the image created by the server 3 may be image data in which a mark is superimposed on the visual structural information, and the image data may be transmitted to the diagnostic terminal 2 and displayed on the display part 24 of the diagnostic terminal 2.

FIG. 9 illustrates a screen on which the sizes of the marks indicating the candidates for the abnormal

sound generating component are changed based on the size information of the components mounted on the diagnosis target apparatus stored in the storage section 23. As illustrated in 70, 71, 72, and 73, the sizes of the marks of the candidates for the abnormal sound generating component displayed in the visual structural information are changed according to the sizes of the candidates for the abnormal sound generating component. The sizes of the candidates for the abnormal sound generating component can be known on the screen in addition to the mounting locations of the candidates for the abnormal sound generating component. This makes it easier to consider the corresponding component when replacing a component. For example, in the illustrated display, since the mounting locations of 71 and 72 are close to each other but the component sizes thereof are different from each other, there is low possibility of mixing up the components at the time of component replacement.

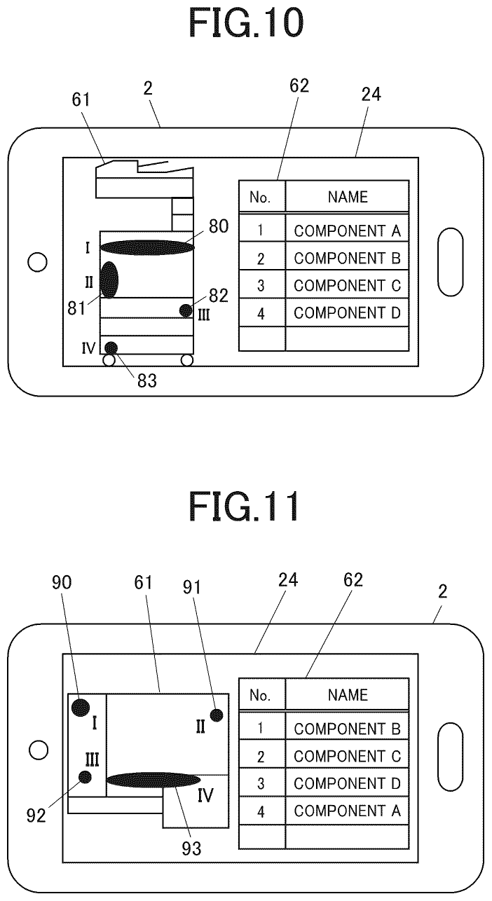

FIG. 10 illustrates a screen when the appearance is changed from the left side view of FIG. 9 to the front view. The marks 70, 71, 72, and 73 in FIG. 9) correspond to marks 80, 81, 82, and 83 in FIG. 10, respectively. By changing the display view, the mounting locations on the target apparatus can be more accurately grasped, the replacement component can be more easily considered, and the possibility of mix-up at the time of component replacement is reduced.

For example, although the mounting locations of 71 and 72 appear to be close in the side view display of FIG. 9. it can be confirmed that the mounting locations of 81 and 82 are far from each other by switching to the front view display of FIG. 10. This also has the effect of making it easier to identify the replacement component, as the service person can arbitrarily eliminate the candidate 82 for the abnormal sound generating component if the service person determines that the abnormal sound is heard from the left side when viewed from the front of the diagnosis target apparatus

FIG. 11 illustrates a screen when the appearance is changed from the left side view of FIG. 9 to the top view. The lower side in FIG. 11 is the front side of the apparatus, and 70, 71, 72, and 73 in FIG. 9) correspond to 93, 90, 91, and 92 in FIG. 11, respectively. Since the display view is changed, the display order of the mounting locations of the diagnosis target apparatus is changed. The Roman numerals I, II, III, and IV in FIG. 9 do not coincide with Roman numerals I, II, III, and IV in FIG. 11. Here, the order of the corresponding component list is rearranged so as to be an order in which the components are displayed from the top in the visual structural information. In the case of the illustrated displays, the order of the component list is described in the order of the components A, B, C, and D in FIG. 9, but is rearranged in the order of the components B, C, D, and A in FIG. 11. By rearranging the component list in the order of the mounting locations on the screen (the order in which the components are displayed from the top of the screen), the component mounting locations and the component names can be easily associated with each other.

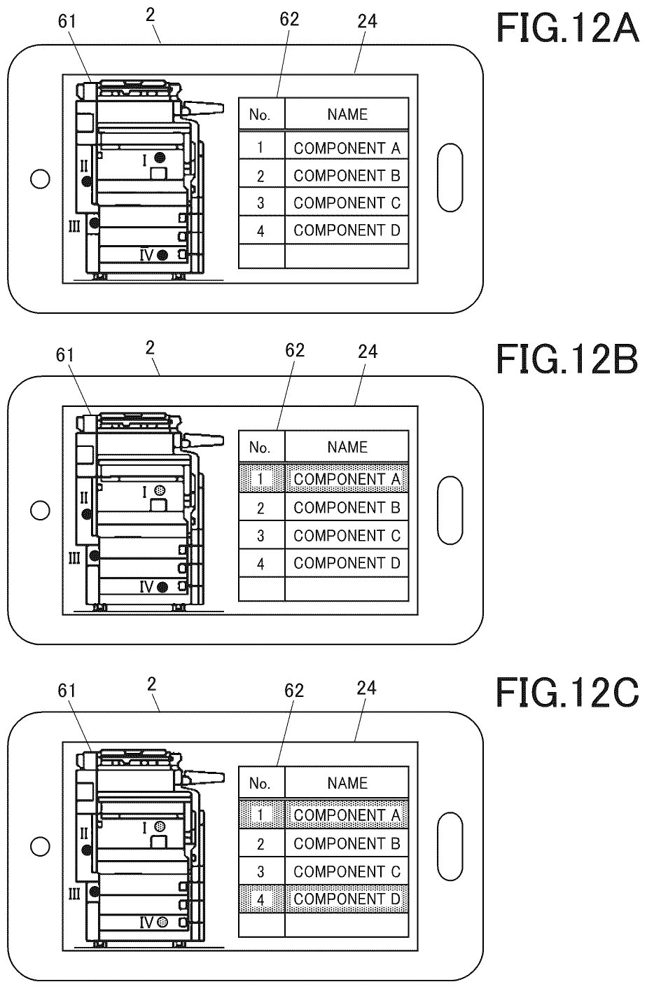

FIGS. 12A, 12B, and 12C illustrate displays for associating the component locations with the component names.

FIG. 12A illustrates the state illustrated in FIG. 8. In this state, when the field of the component A in the component list is selected with the touch screen, the field is changed to a display indicating that the field of the component name has been selected, and the display of the mark at the corresponding mounting location (portion I) in the visual structural information is also changed, as illustrated in FIG. 12B. Next, when the field of the component D in the component list is selected, the display in the field of the component name is changed, and at the same time, the display of the mark at the corresponding mounting location (portion IV) in the visual structural information is also changed, as illustrated in FIG. 12C. Then, in the state of FIG. 12C, when the field of the component D is touched, the display of the field of the component D in the component list and the mark at the mounting location of IV return to their original states, resulting in the state of FIG. 12B.

Here, the change of the display of the selected candidate for the abnormal sound generating component may be changing of colors as in FIG. 12B and FIG. 12C or blinking of the field of the selected component name or the mark of the mounting location. In addition, an arrow indicating the mark of the mounting location may be displayed as long as the selected candidate for the abnormal sound generating component can be visually identified.

In the above description, by touching the component name on the list 62, the mark of the component location in the visual structural information 61 is also changed in conjunction with the touch. Conversely, a configuration may be adopted in which, in conjunction with touching of a mark at a component location in the visual structural information 61, display in the field of the corresponding candidate for the abnormal sound generating component on the list 62 is changed.

In this way, the component name and the component location are displayed in association with each other, and thus it is possible to immediately confirm the location of the candidate for the abnormal sound generating component, and it is possible to further reduce the risk of erroneous recognition.

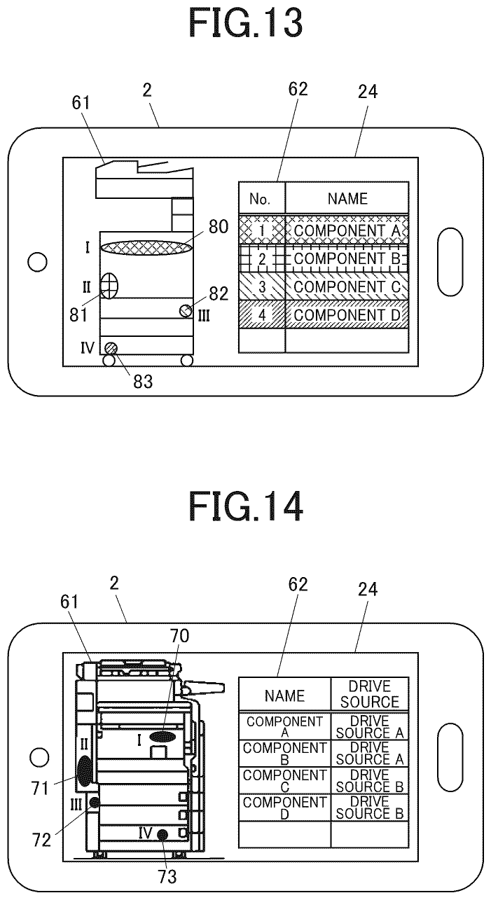

As an example of associating the marks 80 to 83 of the component locations in the visual structural information 61 with the component names, associating them individually by touching the component names on the list or the component locations on the appearance is not the only example. As illustrated in FIG. 13, the component names and the respective marks of the component locations associated with each other may be displayed in the same color or pattern in advance so as to be identifiable. That is, the correspondence between all the component names and the respective marks may be simultaneously grasped by identifying the color, displayed pattern, or the like.

FIG. 14 illustrates a screen on which information about drive sources is added to the information about the candidate components.

On the list of the candidates for the component that may be the cause of the abnormal sound, each of the candidate components and a drive source for driving the candidate component are displayed. In this example, the component A is a component that is operated by moving a drive source A. Similarly, it is indicated that the components B, C, and D are operated by drive sources A, B, and B, respectively, By indicating the drive sources in this manner, even in a case where there is a plurality of candidates for the abnormal sound generating component. if the abnormal sound is generated when only the drive source A is operated, the component C and the component D can be excluded from the candidate components that may be the cause of the abnormal sound. Therefore, it is possible to reduce the burden on the user to investigate the abnormal sound generating component.

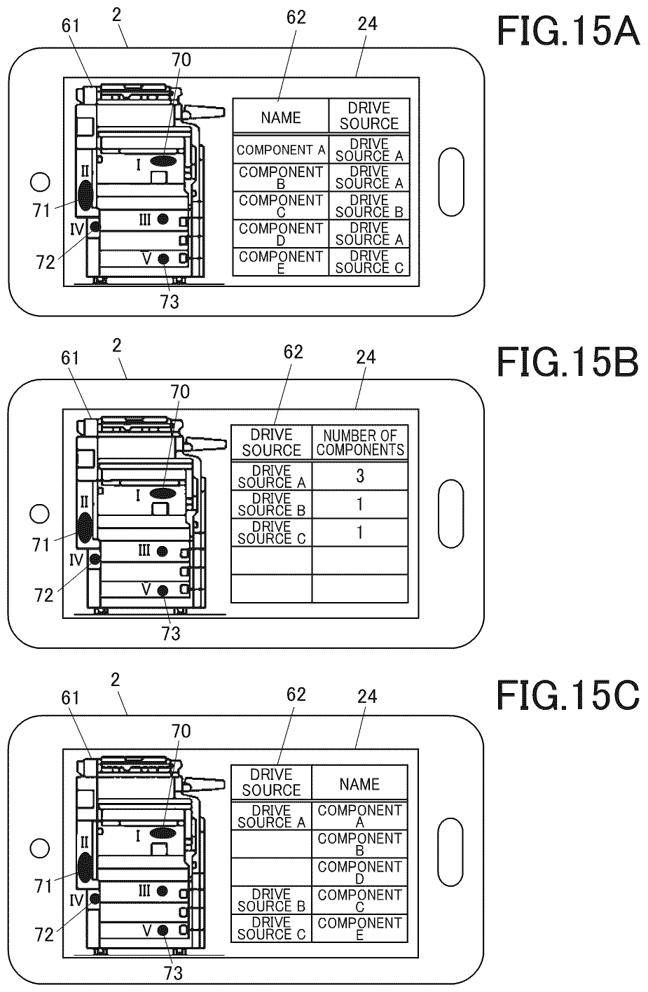

FIGS. 15A to 15C illustrate changing a screen that indicates the correspondence between the candidates for the component that may be the cause of abnormal sound and the drive sources. In particular, this example illustrates a screen when there are many candidates for the component that may be the cause of the abnormal sound.

FIG. 15A is substantially the same screen as FIG. 14 and illustrates a case where the number of extracted component candidates has increased (to five in this example). In the image forming apparatus, since it is assumed that a large number of components are operating at the same period as the component in which the abnormal sound is generated, it is efficient to narrow down the presence or absence of the abnormal sound for each drive source.

Therefore, in the state of FIG. 15A, the screen is swiped, for example, to make a transition to the screen in FIG. 15B.

On the screen illustrated in FIG. 15B, the number of components associated with each drive source among the displayed component candidates is displayed, On the screen of FIG. 15A, it can be seen that the components A, B, and D are driven by the drive source A. On the screen in FIG. 15B, three components are operated by moving the drive source A.

When narrowing down the candidates for the abnormal sound generating component, the maintenance person starts with the drive source that moves the largest number of components simultaneously. Thus, the probability of the abnormal sound generation increases, and if the abnormal sound is reproduced when the drive source A is operated, it is not necessary to check the operations of the remaining drive sources B and C.

Note that instead of the screen in FIG. 15B, not the number of components moved by each drive source but the names of components to be moved by each drive source may be listed, as illustrated in FIG. 15C, which can bring about a similar effect.

In the above description, an example has been described in which the list 62 of the candidates for the abnormal sound generating component and the marks indicating the locations of the candidates for the abnormal sound generating component superimposed on the visual structural information 61 are displayed on the display part 24. As a modification example thereof, when the abnormal sound generating component is to be identified, a region in the diagnosis target apparatus in which the abnormal sound may have been generated may be determined, and a mark such as an ellipse indicating the region may be superimposed on the visual structural information of the diagnosis target apparatus (the image forming apparatus 4) at a corresponding place.

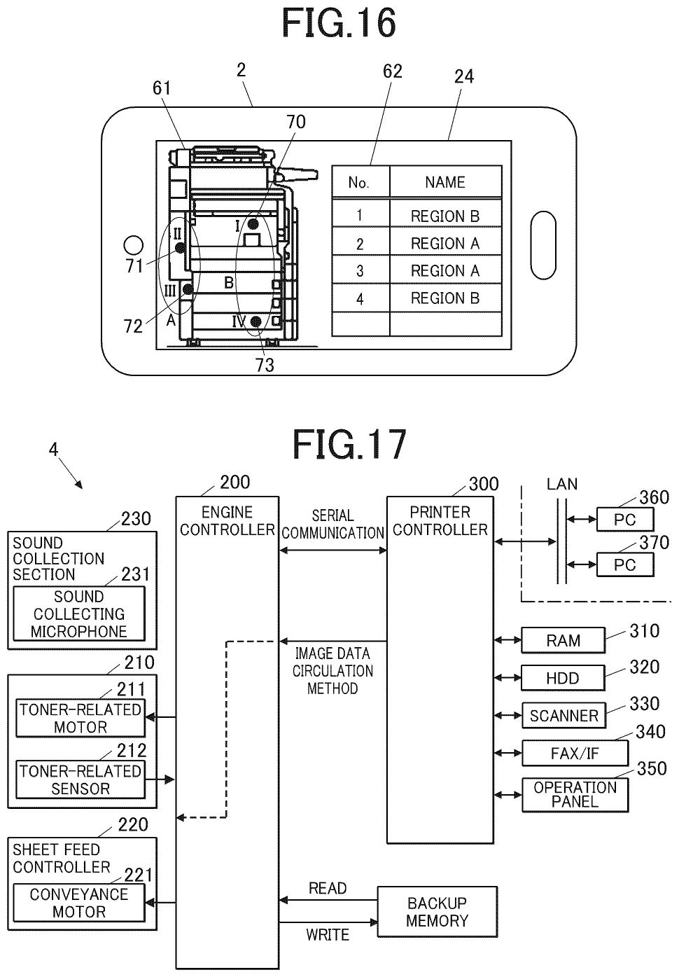

In the example illustrated in FIG. 16, after the candidates for the component that may be the cause of the abnormal sound are extracted based on the result of analyzing the sound data of the abnormal sound, regions in which the abnormal sound may have been generated are displayed based on the mounting location information or the like of the component. In this example, the components are divided into components (components II and III) in a region A on the left side of the visual structural information 61 indicating the left side view of the image forming apparatus and components (components I and IV) in a region B on the right side. If the abnormal sound is generated on the right side when viewed from the left side view of the image forming apparatus 4, it is possible to narrow down to the candidates for the abnormal sound generating component in the region B. In particular, when there are many candidates for the abnormal sound generating component, it is efficient to roughly divide the candidates for the abnormal sound generating component into regions to narrow down the candidates.

Note that the region determination may be performed with reference to the mounting location of the components or with reference to a processing step of the image forming apparatus.

The display formats illustrated in FIG. 10 to FIG. 13 described above can also be used for this type of region division.

### Second Embodiment

In the above-described embodiment, a case in which a sound is collected by a portable terminal has been described, but the present invention is not limited thereto. For example, the image forming apparatus 4 may include a sound collecting microphone. In this case, the image forming apparatus itself functions as the information processing device according to an embodiment of the present invention. In addition, a result of the sound collection by the image forming apparatus 4 may be transmitted to the server 3, or the image forming apparatus 4 itself may diagnose the abnormal sound.

FIG. 17 is a control block diagram illustrating an image forming apparatus 4 as an example of a case where the diagnosis target apparatus itself, which is the source of an abnormal sound, performs everything from analysis to display of an analysis result and the location of a candidate for the abnormal sound generating component. As illustrated in FIG. 17, the image forming apparatus 4 includes an engine controller 200 and a printer controller 300. The engine controller 200 controls a toner controller 210 and a sheet feed controller 220.

The toner controller 210 includes a toner-related motor 211 and controls drive sources for supplying toner from a toner bottle to a sub-hopper and from the sub-hopper to a developer. Further, a toner-related sensor 212 or the like indicating that the toner in the sub-hopper has decreased is coupled to the engine controller 200.

The sheet feed controller 220 includes a conveyance motor 221, and performs conveyance motor control such as starting, stopping, and monitoring during rotation of the conveyance motor. A sound collection section 230 collects a sound during an operation by using a sound collecting microphone 231. The sound collecting microphone 231 may be built in or externally attached to the image forming apparatus 4. In addition, the sound collecting microphones may be installed in a plurality of places of the image forming apparatus 4.

The printer controller 300 controls a RAM 310, an HDD 320, a scanner 330, a FAX/IF 340, and an operation panel 350. The printer controller 300 is capable of communicating with the engine controller 200 via serial communication, and provides image data to the engine controller 200 through an image bus, and also exchange data with PCs 360 to 370 via LAN.

The RAM 310 and HDD 320 are recording media, with RAM 310 being excellent in terms of transfer rate and HDD 320 being inferior to RAM 310 in terms of transfer rate but tending to be advantageous in terms of storage capacity. The scanner 330 reads a document and generates image data. The FAX/IF 340 performs fax transmission and reception of image data. The operation panel 350 includes a touch screen and push-button keys as hardware, functions as a display part that performs various displays for a user, and receives an input operation from the user. A print mode is set by an input from the operation panel 350.

When the user sets a print mode from the operation panel 350, a print preparation command is transmitted from the printer controller 300 to the engine controller 200. When performing a print preparation operation, if it is necessary to change the speed of a polygon motor, the engine controller 200 changes the speed of the polygon motor. When performing a print preparation operation, if it is necessary to change the speed of the conveyance motor 221, the engine controller 200 changes the speed of the conveyance motor 221. If it is determined that a sheet to be conveyed is an envelope, control for moving a fixing unit in a separation direction is performed (if the fixing unit is in a separation state from the beginning, this control is not performed).

The sound collection section 230 collects a sound by the sound collecting microphone 231 when a component such as a motor is operating. When an abnormal sound is detected, analysis of sound data of the abnormal sound, extraction of a candidate for the abnormal sound generating component, display of an analysis result and an extraction result, visual location display of the candidate for the abnormal sound generating component, and the like are performed similarly to the configuration of FIG. 1. Displays of the analysis result and the like are displayed on the operation panel 350.

In such a configuration, the image forming apparatus 4 itself analyzes an abnormal sound, displays an analysis result, extracts and displays a candidate for the abnormal sound generating component, and displays visual location information of the candidate for the abnormal sound generating component, so that a worker does not need to carry the diagnostic terminal 2. In addition, since it is not necessary for the worker to perform the sound collecting work, it is possible to improve work efficiency.

As described above, the information processing program according to the present embodiment causes a computer (the diagnostic terminal 2 or the image forming apparatus 4 as the diagnosis target apparatus) to execute display processing of displaying, on a display part, an image in which visual structural information 61 allowing visual grasp of the structure of the diagnosis target apparatus and a mark (70 to 73 or the like) allowing recognition of a location in the visual structural information corresponding to a component or a region of the diagnosis target apparatus in which an abnormality may have been generated are superimposed, where the component or the region in which the abnormality may have been generated is obtained by analyzing sound data generated in the diagnosis target apparatus (the image forming apparatus 4).

In other words, this information processing program can also be regarded as causing a computer (the diagnostic terminal 2 or the image forming apparatus 4 as the diagnosis target apparatus) to execute display processing of displaying, on a display part (the display part 24 or the operation panel 350), a component or a region of the diagnostic subject apparatus in which an abnormality may have been generated, obtained by analyzing sound data generated in the diagnosis target apparatus, as an image in which a mark (70 to 73 or the like) is superimposed on visual structural information 61 at a corresponding location allowing visually grasp of the structure of the diagnosis target apparatus (the image forming apparatus 4).

Furthermore, this information processing program can also be regarded as causing a computer (the diagnostic terminal 2 or the image forming apparatus 4 as the diagnosis target apparatus) to execute display processing of displaying, on a display part (the display part 24 or the operation panel 350), an image in which a mark (70 to 73 or the like) allowing recognition of a component or a region of the diagnosis target apparatus (the image forming apparatus 4) in which an abnormality may have been generated, obtained by analyzing sound data generated in the diagnosis target apparatus, is superimposed on visual structural information 61 at a location corresponding to the component or the region allowing visual grasp of the structure of the diagnosis target apparatus.

Therefore, when looking at the mark superimposed on the visual structural information 61 displayed on the display part, the worker can visually grasp the location of the component or the region in which the abnormality of the diagnosis target apparatus may have been generated. As a result, even in a case where the worker is not familiar with the mounting location of the components of the diagnosis target apparatus, the worker can easily narrow down the portion of the abnormality by referring to the location of the mark superimposed on the visual structural information. Therefore, it is possible to reduce time for checking the location of the components by a manual or the like, thereby shortening downtime due to maintenance.

Here, the computer does not necessarily have to collect and analyze the sound data generated in the diagnosis target apparatus by itself, and another device may collect and analyze the sound data.

When the collection of the sound data generated in the diagnosis target apparatus is performed by the computer itself, the information processing program may further cause the computer to execute processing of causing a sound collection section 21 to collect the sound data generated in the diagnosis target apparatus.

By causing the computer to collect the sound data, the computer can analyze the collected sound data and perform the subsequent processing. Alternatively, the collected sound data may be transmitted to another apparatus such as a server, and a result of analyzing the sound data by the other apparatus may be received by the computer so that the subsequent processing can be performed by the computer.

Furthermore, the computer may have a function to acquire information about the component or the region of the diagnosis target apparatus in which the abnormality may have been generated, obtained by analyzing the sound data.

That is, the information processing program may cause the computer to execute acquisition processing of acquiring information about the component or the region of the diagnosis target apparatus in which the abnormality may have been generated, where the information is obtained by analyzing the sound data generated in the diagnosis target apparatus, and image creating processing of creating the image in which the mark is superimposed based on the information acquired in the acquisition processing.

Here, the acquisition processing may be processing of causing the sound collection section to collect the sound data generated in the diagnosis target apparatus, analyzing the collected sound data, and extracting the component or the region in which the abnormality may have been generated. Since the computer performs the processes from the collection to analysis of the sound data, the computer can function as a standalone diagnostic device.

In addition, the acquisition processing may be processing of receiving the information about the component or the region in which the abnormality of the diagnosis target apparatus may have been generated, which is obtained by another apparatus by analyzing the sound data generated in the diagnosis target apparatus. In this case, the sound data is analyzed by the server, and the computer receives the result and performs the subsequent processing, thereby reducing the load on the computer.

There are various ways in which the image obtained by the display processing is displayed on the display part. When there are a plurality of components or regions in which the abnormality may have been generated, the display processing may display, on the display part, an image in which marks are superimposed on the visual structural information at the corresponding locations of the respective components or regions in which the abnormality may have been generated.

In addition, the display processing can cause the display part to display a list of the components or regions in which the abnormality may have been generated. Displaying the components or regions in which the abnormality may have been generated on a list enables the worker to visually grasp the locations of the components or regions in which the abnormality may have been generated from the image in which the marks are superimposed and also grasp the details thereof.

The display processing can cause the list 62 to display the components or regions in which the abnormality may have been generated so as to match the display order of the marks superimposed on the visual structural information 61. By performing such display, the display order of the components or regions in the visual structural information in which the abnormality may have been generated, i.e., the display order of the marks, matches the display order of the components or regions on the list in which the abnormality may have been generated. This makes it easier to understand the correspondence relationship between the marks and the components or regions and eliminates the risk of erroneously recognizing the correspondence relationship.

The display processing can change the sizes of the marks of the components superimposed on the visual structural information based on the size information of the components mounted on the diagnosis target apparatus. In addition to the locations of the components in which the abnormality may have been generated in the visual structural information 61, the sizes of the components in which the abnormality may have been generated can also be grasped by looking at the sizes of the marks. This makes it easier to consider the corresponding component when replacing a component.

The visual structural information displayed on the display part is changeable, and when the visual structural information to be displayed on the display part is changed, the display processing can arrange the display order of the list so as to match the display order of the marks superimposed on the changed visual structural information. By arranging the display order of the list to match the display order of the marks in the changed visual structural information, the mounting locations on the diagnosis target apparatus can be grasped more accurately, the replacement component can be more easily considered, and the possibility of mix-up at the time of component replacement is reduced.

The display processing may display a tool for selecting a component or region displayed on the list in which the abnormality may have been generated. In response to a component or region in which the abnormality may have been generated being selected, the display processing may display a mark superimposed on the visual structural information at the corresponding location of the selected component or region in an explicitly identifiable manner.

By displaying the component or region and the location thereof in the visual structural information in association with each other in this way, it is possible to immediately confirm the location of the component or region in which the abnormality may have been generated, and it is possible to further reduce the risk of erroneous recognition.

In the display processing, based on information about drive sources of the components of the diagnosis target apparatus, information about the drive sources that drive the components in which the abnormality may have been generated can be displayed on the list 62 of the components.

By indicating the drive sources in this way, even when there is a plurality of components in which the abnormality may have been generated, it is possible to narrow down the components in which the abnormality may have been generated by operating a specific drive source, and it is possible to reduce the burden of investigation on the worker.

In the display processing, the content of the list 62 can be changed so that the information about the components in which the abnormality may have been generated is grouped for each drive source. Here, the information about the components in which the abnormality may have been generated may be the number of components moved by each drive source, or the names of the components moved by each drive source.

When narrowing down the components in which the abnormality may have been generated, starting with the drive source that moves the largest number of components simultaneously increases the probability of generation of the abnormal sound, thereby making it possible to efficiently find the component in which the abnormality has been generated.

The information processing device (the diagnostic terminal 2 or the image forming apparatus 4 as the diagnosis target apparatus) according to the present embodiment includes a display part (the display part 24 or the operation panel 350) that displays information, and a display controller 26 that displays, on the display part, an image in which visual structural information 61 allowing visual grasp of the structure of the diagnosis target apparatus and a mark (70 to 73 or the like) allowing recognition of a location in the visual structural information corresponding to a component or a region of the diagnosis target apparatus in which an abnormality may have been generated are superimposed, where the component or the region in which the abnormality may have been generated is obtained by analyzing sound data generated in the diagnosis target apparatus (the image forming apparatus 4).

Therefore, when looking at the mark (70 to 73 or the like) superimposed on the visual structural information 61 displayed on the display part 24, the worker can visually grasp the location of the component or the region in which the abnormality of the diagnosis target apparatus may have been generated. As a result, even in a case where the worker is not familiar with the mounting location of the components of the diagnosis target apparatus, the worker can easily narrow down the portion of the abnormality by referring to the location of the mark superimposed on the visual structural information. Therefore, it is possible to reduce time for checking the location of the component by a manual or the like, thereby shortening downtime due to maintenance.

Here, the information processing device may include the sound collection section 21 or 230 that collects the sound data.

By performing the collection of the sound data by the sound collection section 21 or 230 of the information processing device, the information processing device can analyze the collected sound data and perform the subsequent processing. Furthermore, the collected sound data can be transmitted to another apparatus such as a server, and a result of analyzing the sound data by the other apparatus can be received by the information processing device so that the information processing device can perform the subsequent processing.

The information processing device may further include an acquisition section (acquirer) that acquires information about the component or the region in which the abnormality of the diagnosis target apparatus may have been generated, the information being obtained by analyzing the sound data generated in the diagnosis target apparatus, and an image forming section (image former) that creates the image based on the information acquired by the acquisition section.

Here, the acquisition section may include a sound collection section 21 that collects the sound data generated in the diagnosis target apparatus, and a diagnostic section 22 that analyzes the sound data collected by the sound collection section and extracts the component or the region in which the abnormality may have been generated. Since the information processing device performs the processes from the collection to analysis of the sound data, the information processing device can function as a standalone diagnostic device.

Furthermore, the acquisition section may include a receiving unit (receiver) that receives the information about the component or the region in which the abnormality may have been generated, which is obtained by another device by analyzing the sound data generated in the diagnosis target apparatus. The receiving unit may receive information sent from a communication line via the communication section 25 or a storage medium. In this case, the sound data is analyzed by the server, and the information processing device receives the result and performs the subsequent processing, thereby reducing the load on the information processing device (diagnostic terminal).

In addition, the information processing device further includes an apparatus information storage section (storage section 23) that stores mounting location information for specifying the mounting location of the components of the diagnosis target apparatus and the visual structural information with which the structure of the diagnosis target apparatus can be visually grasped. Further, the display controller 26 may display the visual structural information 61 stored in the apparatus information storage section (storage section 23) on the display part 24, and may superimpose, based on the mounting location information, the mark (70 to 73 or the like) on the visual structural information 61 displayed on the display part 24 at the corresponding location of the component or the region in which the abnormality may have been generated.

There are various ways in which the display controller 26 causes the display part 24 to display the image. When there is a plurality of components or regions in which the abnormality may have been generated, the display controller 26 may display, on the display part 24, an image in which marks are superimposed on the visual structural information at the corresponding locations of the respective components or the regions in which the abnormality may have been generated.

In addition, the display controller 26 can cause the display part 24 to display a list of the components or the regions in which the abnormality may have been generated. Displaying the components or the regions in which the abnormality may have been generated on a list enables the worker to grasp visual location information that can be grasped from the image in which the marks indicating the respective components or regions in which the abnormality may have been generated are superimposed and also grasp the details thereof.

Here, the display controller 26 may display, on the list 62, the components in which the abnormality may have been generated so as to match the display order of the marks superimposed on the visual structural information.

By performing such display, the display order of the components or regions in the visual structural information in which the abnormality may have been generated, i.e., the display order of the marks, matches the locations of the components or regions in which the abnormality may have been generated on the list, i.e., the display order on the list. This makes it easier to understand the correspondence relationship and eliminates the risk of erroneously recognizing the correspondence relationship.

Furthermore, the apparatus information storage section (storage section 23) may further store size information about the components mounted on the diagnosis target apparatus, and the display controller 26 may change, based on the size information, the sizes of the marks on the respective components in which the abnormality may have been generated.

In addition to the locations of the components in which the abnormality may have been generated in the visual structural information 61, the sizes of the components in which the abnormality may have been generated can also be grasped by looking at the sizes of the marks. This makes it easier to consider the corresponding component when replacing a component.

The display controller 26 can change the visual structural information 61 displayed on the display part 24. When the visual structural information 61 to be displayed on the display part is changed, the display controller 26 may arrange the display order of the list 62 so as to match the display order of the marks superimposed on the changed visual structural information 61.

By arranging the display order of the list to match the display order of the marks in the changed visual structural information, the mounting locations on the target apparatus can be grasped more accurately, the replacement component can be more easily considered, and the possibility of mix-up at the time of component replacement is reduced.

The display controller 26 may display a selection tool for selecting a candidate for the component in which the abnormality may have been generated from the list 62 and display a mark superimposed on the visual structural information of the candidate selected by the selection tool in an explicitly identifiable manner. By displaying the component or the region and the location thereof in the visual structural information 61 in association with each other in this way, it is possible to immediately confirm the location of the component or the region in which the abnormality may have been generated, and it is possible to further reduce the risk of erroneous recognition.

The apparatus information storage section (storage section 23) may further store information about drive sources of the components of the diagnosis target apparatus. The display controller 26 may display, on the list 62, the drive sources that drive the components in which the abnormality may have been generated based on the information about the drive sources.

By displaying the drive sources in this way, even when there is a plurality of components in which the abnormality may have been generated, it is possible to narrow down the components in which the abnormality may have been generated by operating a specific drive source, and it is possible to reduce the burden of investigation on the worker.

The display controller may change the content of the list 62 so that the information about the components in which the abnormality may have been generated is grouped for each drive source on the list. Here, the information about the components in which the abnormality may have been generated may be the number of components moved by each drive source, or a list of the names of the components moved by each drive source.

When narrowing down the components in which the abnormality may have been generated, starting with the drive source that moves the largest number of components simultaneously increases the probability of generation of the abnormal sound, thereby making it possible to efficiently find the component in which the abnormality has been generated.

The image in which the mark that enables recognition of the corresponding portion in the visual structural information of the component or the region in which the abnormality may have been generated is superimposed on the visual structural information may be raster data such as an image or vector data such as a figure.

### Supplemental

Although the information processing program and the information processing device according to the present invention have been described with reference to the embodiments and the modification examples, the present invention is not limited to the above-described embodiments and modification examples. The present invention also includes embodiments obtained by applying various modification examples conceived by those skilled in the art to the above-described embodiments and modification examples, and embodiments realized by suitably combining the constituent elements and functions in the embodiments and modifications without departing from the spirit of the present invention. The scope of the present invention is to be interpreted by the appended claims.

### INDUSTRIAL APPLICABILITY

The present invention is useful as a technology for visually grasping a location or a range of a component in which an abnormality may have been generated, which is obtained by analyzing sound data generated in a diagnosis target apparatus.

Although embodiments of the present invention have been described and shown in detail, the disclosed embodiments are made for purposes of illustration and example only and not limitation. The scope of the present invention should be interpreted by terms of the appended claims.

What is claimed is:

1. A non-transitory computer-readable recording medium storing an information processing program that causes a computer to execute display processing of displaying, on a display part, an image of visual structural information allowing visual grasp of a structure of a diagnosis target apparatus and a mark superimposed on the visual structural information to allow recognition of a location in the visual structural information corresponding to a component or a region of the diagnosis target apparatus in which an abnormality may have been generated, the component or the region being obtained by analyzing sound data on a sound generated in the diagnosis target apparatus.

2. The recording medium according to claim 1, wherein the information processing program further causes the computer to execute collection processing of collecting the sound generated in the diagnosis target apparatus by a sound collector.

3. The recording medium according to claim 1, wherein the information processing program further causes the computer to execute
acquisition processing of acquiring information about the component or the region of the diagnosis target apparatus in which the abnormality may have been generated, the information being obtained by analyzing the sound data on the sound generated in the diagnosis target apparatus, and
image formation processing of creating the image based on the information acquired in the acquisition processing.

4. The recording medium according to claim 3, wherein the acquisition processing includes
causing a sound collector to collect the sound generated in the diagnosis target apparatus, and
analyzing the sound data on the collected sound to extract the component or the region in which the abnormality may have been generated.

5. The recording medium according to claim 3, wherein
the information about the component or the region in which the abnormality of the diagnosis target apparatus may have been generated is obtained by analyzing the sound data on the sound generated in the diagnosis target apparatus by an external device, and
the acquisition processing includes receiving the information.

6. The recording medium according to claim 1, wherein
the component or the region includes a plurality of components or regions in which the abnormality may have been generated.
the mark includes a plurality of marks, and
the display processing includes displaying, on the display part, the image in which the plurality of marks is superimposed on the visual structural information at corresponding locations of the respective plurality of components or regions.

7. The recording medium according to claim 1, wherein the display processing includes displaying, on the display part, a list of the component or the region in which the abnormality may have been generated.

8. The recording medium according to claim 7, wherein the display processing includes arranging the list so that a display order of the component or the region in which the abnormality may have been generated corresponds to a display order of the mark superimposed on the visual structural information.

9. The recording medium according to claim 1, wherein the display processing includes changing, based on size information of a component mounted on the diagnosis target apparatus, a size of the mark superimposed on the visual structural information.

10. The recording medium according to claim 8, wherein
the visual structural information displayed on the display part is changeable, and
the display processing includes, in response to the visual structural information to be displayed on the display part being changed, rearranging the list so that the display order of the component or the region corresponds to the display order of the mark superimposed on the changed visual structural information.

11. The recording medium according to claim 7, wherein the display processing includes
displaying a tool for selecting the component or region, displayed on the list, in which the abnormality may have been generated, and
in response to the component or region in which the abnormality may have been generated being selected, displaying the mark superimposed on the visual structural information at the corresponding location of the selected component or region in an explicitly identifiable manner.

12. The recording medium according to claim 7, wherein the display processing includes displaying, based on information about a drive source of a component of the diagnosis target apparatus, information about the drive source that drives the component on the list of the component in which the abnormality may have been generated.

13. An information processing device comprising:
a display part that displays information; and
a display processor that causes the display part to display an image in which a mark allowing recognition of a location corresponding to a component or a region of a diagnosis target apparatus in which an abnormality may have been generated is superimposed on visual structural information allowing visual grasp of a structure of the diagnosis target apparatus, the component or the region being obtained by analyzing sound data on a sound generated in the diagnosis target apparatus.

14. The information processing device according to claim 13, further comprising a sound collector that collects the sound.

15. The information processing device according to claim 13, further comprising:
an acquirer that acquires information about the component or the region in which the abnormality of the diagnosis target apparatus may have been generated, the information being obtained by analyzing the sound data on the sound generated in the diagnosis target apparatus; and an image former that creates the image based on the information acquired by the acquirer.

16. The information processing device according to claim 15, wherein the acquirer includes
a sound collector that collects the sound generated in the diagnosis target apparatus, and
an analyzer that analyzes the sound data on the sound collected by the sound collector and extracts the component or the region in which the abnormality may have been generated.

17. The information processing device according to claim 15, wherein
the information about the component or the region in which the abnormality may have been generated is obtained by analyzing the sound data on the sound generated in the diagnosis target apparatus by an external device, and
the acquirer includes a receiver that receives the information.

18. The information processing device according to claim 13, further comprising an apparatus information storage section that stores
mounting location information for specifying a location of a component mounted on the diagnosis target apparatus and
the visual structural information allowing the visual grasp of the structure of the diagnosis target apparatus, wherein the display processor
displays the visual structural information stored in the apparatus information storage section on the display part, and
superimposes, based on the mounting location information, the mark on the visual structural information displayed on the display part at the location corresponding to the component or the region in which the abnormality may have been generated.

19. The information processing device according to claim 13, wherein
the component or the region includes a plurality of components or regions in which the abnormality may have been generated.
the mark includes a plurality of marks, and
the display processor causes the display part to display the image in which the plurality of marks is superimposed on the visual structural information at corresponding locations of the respective plurality of components or regions.

20. The information processing device according to claim 13, wherein the display processor causes the display part to display a list of the component or the region in which the abnormality may have been generated.

21. The information processing device according to claim 20, wherein the display processor arranges the list so that a display order of the component or the region in which the abnormality may have been generated corresponds to a display order of the mark superimposed on the visual structural information.

22. The information processing device according to claim 18, wherein
the apparatus information storage section further stores size information of the component mounted on the diagnosis target apparatus, and
the display processor changes, based on the size information, a size of the mark on the component in which the abnormality may have been generated.

23. The information processing device according to claim 21, wherein the display processor
is configured to change the visual structural information displayed on the display part, and
in response to the visual structural information to be displayed on the display part being changed, rearranges the list so that the display order of the component or the region corresponds to the display order of the mark superimposed on the changed visual structural information.

24. The information processing device according to claim 20, wherein the display processor
displays a selection tool for selecting, from the list, the component or region in which the abnormality may have been generated, and
displays the mark superimposed on the visual structural information of the component or region selected by the selection tool in an explicitly identifiable manner.

25. The information processing device according to claim 20, further comprising an apparatus information storage section that stores information about a drive source of a component of the diagnosis target apparatus, wherein the display processor displays, on the list, the drive source that drives the component in which the abnormality may have been generated based on the information about the drive source.
